(19) United States
(12) Patent Application Publication
(10) Pub. No.: US 2004/0154739 A1
(43) Pub. Date: Aug. 12, 2004

(54) Perishable food labeler

(76) Inventor: John M. Shanahan, Balboa Island, CA (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/360,679

(22) Filed: Feb. 7, 2003

(51) Int. Cl. B32B 31/00; B41M 1/00

(52) U.S. Cl. 156/277; 156/538

(57) ABSTRACT

The present invention is a perishable food labeler is provided for imprinting a food item with a date stamp. In one embodiment of the present invention, a perishable food labeler is provided that correlates a food item designation to a spoilage date through the use of a database. The spoilage date is printed on a label, which, in turn, is fixedly applied to the food item corresponding to the designation. Thus, the expiration date of the food item is clearly visible, reducing the potential instances of ingestion of spoiled food.

### FIELD OF THE INVENTION

This invention relates to a device and method for labeling items that are time sensitive. In particular, this invention relates to labeling perishable food items with an expiration or spoilage date to ensure consumption or use prior to spoilage or expiration of the food item.

### BACKGROUND OF THE INVENTION

Homeowners, grocery stores, restaurants and institutions are constantly battling against waste of food that has become inedible due to spoilage. Spoilage results in two distinct problems. First, mild to severe medical problems may result from the ingestion of food that appears to be unspoiled, when, in fact, the food has spoiled. Ingestion of spoiled food may open the provider of the food up to public ridicule and/or legal responsibility.

Further, spoiled food is wasted food and effectively wasted money. In businesses where profit margins are slim, such as restaurants and grocery stores, food waste in any form is detrimental to profitability.

A variety of devices and methods have been employed in the past to help reduce the amount of spoilage. The simplest method is maintaining a list of all the items susceptible to spoilage. This method, however, is workable only on a very small scale, such as in a home, and even then a great deal of diligence is required to update the list as food items are eaten or discarded. In addition, several electronic devices have been used to more fully automate keeping the list. These electronic devices may also keep track of the time remaining before spoilage, and/or display a warning light when the item is spoiled. These electronic devices, however, are inefficient to use, especially when large amounts of food must be tracked at one time.

Accordingly, the inventor has recognized that a more efficient method and device is needed to reduce spoilage of perishable food.

### SUMMARY OF THE INVENTION

In accordance with the present invention, a perishable food labeler is provided for imprinting a food item with a date stamp. In one embodiment of the present invention, a perishable food labeler is provided that correlates a food item designation to a spoilage date through the use of a database. The spoilage date is printed on a label, which, in turn, is fixedly applied to the food item corresponding to the designation. Thus, the expiration date of the food item is clearly visible, reducing the potential instances of ingestion of spoiled food.

In another embodiment of the present invention, a perishable food labeler is provided that includes a time display, at least one input device and at least one output device that serves to print a label with at least a date stamp for placement on a food item in response to input from the input device. Thus, the date the food item is placed into storage is identifiable on the food item, reducing the potential instances of ingestion of spoiled food.

### BRIEF DESCRIPTION OF THE DRAWINGS

The features and inventive aspects of the present invention will become more apparent upon reading the following detailed description, claims, and drawings, of which the following is a brief description:

FIG. 1 shows an embodiment of a perishable food labeler in accordance with the present invention.

FIG. 2 shows another, hand held embodiment of the present invention.

FIG. 3 shows another embodiment of the present invention.

### DETAILED DESCRIPTION OF THE PREFERRED EMBODIMENTS

The perishable food labeler includes an input device, a database, and an output device. The three components of the labeler may be located together in one integral device, whether it is hand-held, laptop or desktop. Alternatively, the components of the labeler may be separate from one another such that they communicate through a land line or wirelessly. In its simplest embodiment, the labeler may be a dedicated system. The labeler may also be included in a larger system which helps manage the overall inventory of the home, store, restaurant or institution using the labeler.

Any device that can detect information may be a suitable input device. In the preferred embodiment, the input device is a keypad. The keys of the keypad are used to input a alphanumeric designation for a particular food item selected from a list of pre-programmed designations. The designations are preferably two or three digits, but may be any convenient length. The keypad may include keys or functions which allow the operator to program the list of designations or to create designations, as needed.

The input device may also be a barcode scanner. Barcodes are widely used to uniquely identify food items and thus could be utilized as food item designations. Barcode scanners are adept input devices for reading the food item designations. Alternatively, a combination of input devices may be warranted, given that some food items do not currently utilize barcode identification, such as fresh fruits and vegetables.

The database is used to associate a food item designation with information pertaining to the length of time until the food item becomes spoiled. Usually measured in days, the spoilage date refers to the number of days, from the current day, until the food item is no longer edible or sellable.

The database uses a look-up table which correlates food item designations with relevant information such as the spoilage date. Other relevant information may include the current date and time, the name of the food item, vendor information, and billing information.

The database is incorporated into a computer which may include such things as a processor, a monitor, a keyboard, a docking station, and memory and storage devices to facilitate the creation, use and maintenance of the database. Once the designation is associated with the relevant information, the information is made available to the operator via the output device.

In addition to entries in the database which correlate the designations for specific food items to relevant information, the database may also include designations for generic information. Generic designations are particularly useful for a skilled operator who is familiar with the spoilage dates of most of the food items being labeled or when a more specific designation has not been programmed into the database. For example, a generic designation could correspond to a spoilage date that is 7 days into the future.

The output device is preferably a printer which prints the information received from the database on an adhesive label, which can be fixedly attached to the desired food item or a container for a food item. Alternately, a printer that is capable of printing information directly on the food item may be provided, such as an ink jet printer.

Additional output devices, such as alphanumeric or video displays, or audio speakers, may be used in conjunction with the printer. These additional output devices may help ensure the accuracy of the food item designation. An alphanumeric display, video display or an audible cue may allow the operator to confirm that the label to be printed, in fact, matches the food item to be labeled. In addition, such an additional output display would allow the operator to scroll through all the food items if a particular designation was unknown or forgotten.

The labeler also may include a mounting feature that allows the labeler to be mounted to or near the place of most frequent use of the labeler. For example, in homes the labeler may be mounted to a refrigerator or pantry so that food items can be labeled as the food items are placed in the refrigerator or pantry. Alternately, for restaurants, the labeler may be mounted near a loading dock so that food items can be labeled as the food items are unloaded from the delivery truck.

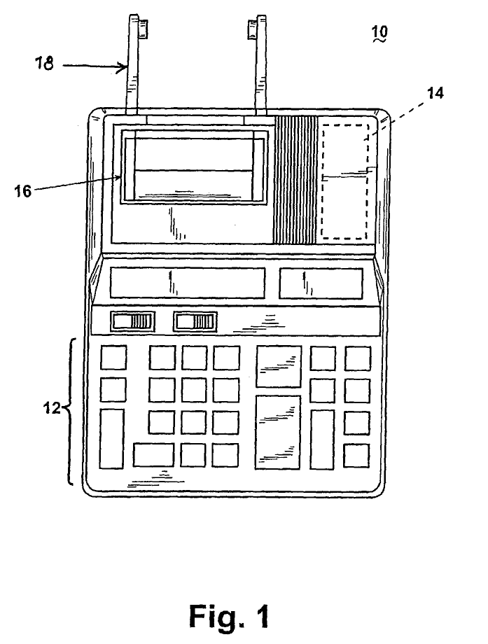

FIG. 1 shows a first embodiment of the present invention similar to a printing calculator. A perishable food labeler 10 in accordance with the present invention includes a keypad 12 as an input device, a database (shown schematically at 14) and a printer 16. In one embodiment, perishable food labeler 10 includes a spool holder 18. Spool holder 18 preferably carries a spool of adhesive labels (not shown) that are fed in to the printing mechanism of perishable food labeler 10.

Operation of the perishable food labeler will now be described with reference to FIG. 1. An operator identifies a perishable food item, such as fruit, and then uses keypad 12 to input the proper food item designation. Database 14 associates the designation to at least the spoilage date of the food item. The spoilage date information is then printed on an adhesive label (not shown) by printer 16. Upon completion of printing, the operator applies the label to the food item or its container. The food item may then be appropriately stored. In another embodiment, the spoilage date information may be printed directly to the food item or container.

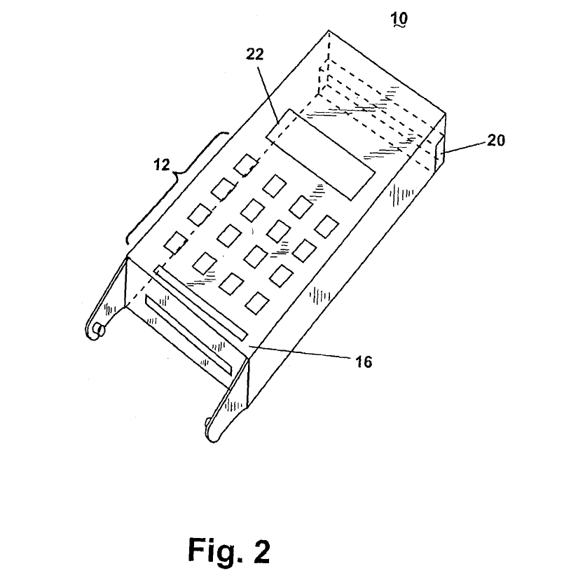

FIG. 2 shows another embodiment of the present invention. Perishable food labeler 10 includes both keypad 12 and a barcode scanner 20 as input devices, a database (not shown), printer 16 and alphanumeric display 22. Labeler 10 of this embodiment is a self-contained, hand-held device. With a hand held device, a docking station (not shown) may be utilized to recharge batteries and/or transmit data, via land line or wirelessly, to another computer which tracks overall inventory. Alternately, the hand held device may transmit data wirelessly to another computer.

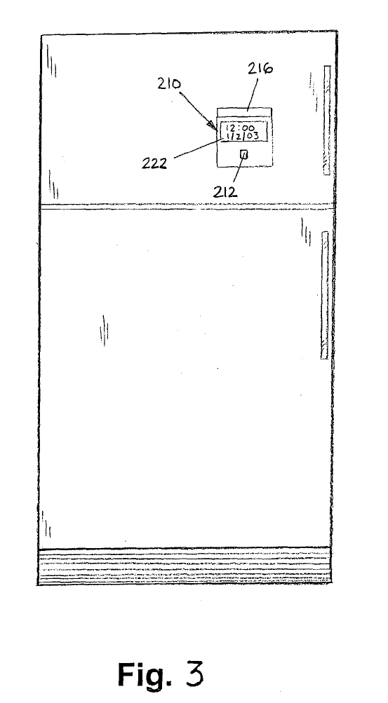

FIG. 3 shows another embodiment of the present invention. Perishable food labeler 210 includes a keypad 212 having at least one input key, a printer 216 and a time display 222. The term “time display” is used herein to describe devices that provide time and date information, such as, for example, a digital or mechanical clock and an electronic calendar. In the disclosed embodiment, time display 222 functions as a digital alphanumeric clock having a calendar function.

Labeler 210 of this embodiment also includes a mounting feature, such as a magnet or mounting bracket, which allows it to be secured to a pantry or refrigerator, as shown in FIG. 3. In the illustrated embodiment, labeler 210 includes a single input key. As the food item is placed into the refrigerator, an operator uses the single input key to request a printed label. The current time and/or date is sent from time display 222 to printer 116 and printed on an adhesive label (not shown). Therefore, as the food item is place in the refrigerator, the operator labels the food item with the date the food item entered the refrigerator.

Alternatively, keypad 212 may include a database (not shown) and several input keys, as shown in FIG. 1 and described above. In this embodiment, an operator identifies a perishable food item, such as fruit, and then uses keypad 212 to input the proper food item designation. The database associates the designation to at least the spoilage date of the food item. The spoilage date information is then printed on an adhesive label (not shown) using printer 216. Upon completion of printing, the operator applies the label to the food item or its container. The food item may then be appropriately stored in the refrigerator.

Table I includes a sample list of food items and their designations. Table 2 shows a sample database of designations and spoilage dates.

TABLE 1

| Food Item | Food Item Designation |
|---|---|
| Bananas | 100 |
| Potatoes | 110 |
| Lettuce | 120 |
| Eggs | 130 |
| Generic 1 | 140 |
| Generic 2 | 150 |

TABLE 2

| Food item | Spoilage | [other |
|---|---|---|
| designation | date | information] |
| 100 | 7 | . . . |
| 110 | 21 | . . . |
| 120 | 5 | . . . |
| 130 | 14 | . . . |
| 140 | 2 | . . . |
| 150 | 5 | . . . |
| . | . | . |
| . | . | . |
| . | . | . |

For labeling potatoes with a spoilage date, the operator would enter the food item designation 110 into the keypad. The database would associate designation 110 with a spoilage date and direct the printer to print an adhesive label indicating the spoilage date was 21 days in the future. The operator would apply the label to the potatoes. With each bag of potatoes so labeled, efficient use the labeled potatoes could then be made, i.e., bags with more pressing spoilage dates would be used or sold prior to bags with spoilage dates further in the future.

Table 3 shows a sample database of designations and food spoilage calendar dates.

TABLE 3

| Food item | Spoilage | [other |
|---|---|---|
| designation | date | information] |
| 100 | Jan. 2, 20XX | . . . |
| 110 | Jan. 12, 20XX | . . . |
| 120 | Jan. 5, 20XX | . . . |
| 130 | Feb. 7, 20XX | . . . |
| 140 | Jan. 7, 20XX | . . . |
| 150 | Jan. 24, 20XX | . . . |
| . | . | . |
| . | . | . |
| . | . | . |

Alternatively, as shown in Table 3, the perishable food labeler can print a label indicating a food spoilage calendar date. For labeling potatoes with a food spoilage calendar date, the operator would enter the food item designation 110 into the keypad. The database would associate designation 110 with a spoilage calendar date and direct the printer to print an adhesive label indicating the calendar date of January 12, 20__.

When a barcode scanner is used as the input device, the operator would scan the food item's bar code. The bar code acts as the item's designation. Otherwise, the barcode scanner embodiment would work in substantially the same way as a keypad embodiment.

The present invention may be utilized in other circumstances where deadlines or due dates have to be met. This labeler is particularly useful where more complex file or case tracking systems are not needed and in service industries were the customer leaves an item to be serviced. For example, labeling framing jobs at a frame shop, labeling repair jobs at an appliance repair shop, or clothing on sale at a consignment store.

While the invention has been specifically described in connection with certain specific embodiments thereof, it is to be understood that this is by way of illustration and not of limitation, and the scope of the appended claims should be construed as broadly as the prior art will permit.

What is claimed is:

1. A perishable food labeler, comprising:
at least one input device for receiving a food item designation from an operator;
a database that correlates the food item designation to a spoilage date; and
at least one output device that serves to imprint a food item with at least the spoilage date.

2. The labeler of claim 1, wherein the at least one input device is a keypad.

3. The labeler of claim 1, wherein the at least one input device is a barcode scanner.

4. The labeler of claim 1, further including an alphanumeric display.

5. The labeler of claim 1, wherein the output device further includes adhesive labels such that said adhesive labels may be fixedly secured to the food item.

6. The labeler of claim 5, wherein the at least one input device, the database and the at least one output device are combined into a hand held device.

7. The labeler of claim 6, further including a docking station adapted to transmit data from the handheld device to a computer.

8. The labeler of claim 1, wherein the food spoilage date is a calendar date.

9. A method of preventing food spoilage:
inputting a food item designation;
correlating the designation to at least a spoilage date;
printing the spoilage date on an adhesive label; and
applying the label a food item.

10. The method of claim 9, further including the step of:
discarding the food item at least by the spoilage date.

11. A perishable food labeler, comprising:
a time display;
at least one input device; and
at least one output device that serves to print a label with at least a date stamp for placement on a food item in response to input from the input device.

12. The labeler of claim 11, wherein the least one input device receives a food item designation from an operator.

13. The labeler of claim 12, further including a database that correlates the food item designation to a spoilage date.

14. The labeler of claim 13, wherein the at least one output device serves to print the label with at least the spoilage date.
